(19) United States
(12) Patent Application Publication
(10) Pub. No.: US 2003/0168225 A1
(43) Pub. Date: Sep. 11, 2003

(54) Apparatus and method for suppressing fires

(76) Inventors: Phillip Raymond Michael Denne, Dorset (GB); John Russell Prewer, Kent (GB)

Correspondence Address: Joseph R Robinson, Darby & Darby, Post Office Box 5257, New York, NY, 10150-5257, US

(21) Appl. No.: 10/220,078

(22) PCT Filed: Feb. 22, 2001
(86) PCT No.: PCT/GB01/00740

(51) Int. Cl. A62C 2/00

(52) U.S. Cl. 169/46

(57) ABSTRACT

Fire suppressant apparatus comprises a container (11) which may be spherical or cylindrical with domed ends, housing a liquid such as water in an interior chamber (25) and having low pressure nozzles (19, 20) housed in recesses covered by caps or covers (26, 27). A gas generator (22) is also located within the chamber (25) and contains a stable combustible material (21) which can be ignited by an ignitor (26) triggered by a sensor (28). The gas generated by combustion of the material (21) drives the water out through the nozzles (19, 20) to form fine droplets the majority of which are in the region of 50 μm without creating a high pressure within the chamber (25). The burn time of the gas generator material is 15 to 20 seconds so that a mist or fog lasting at least this duration is generated in the protected environment and can be carried to the seat of a fire by convection currents within this environment.

The present invention relates generally to apparatus for suppressing fires, and to a method of suppressing a fire in a protected environment in order to afford occupants thereof a window of opportunity to escape without inhaling the hot combustion products which are a major cause of injury and death in fires.

There are two primary physical effects which are used to combat fires, namely depriving the fire of oxygen and cooling the combustible material to below its ignition temperature. Most fire extinguishers operate on the former principle, seeking to smother the flames with a fire retardant chemical which may be in the form of a powder, liquid or foam, to deprive the fire of oxygen and prevent further combustion thereby extinguishing the fire.

If a fire gets well established the quantities of fire extinguishing materials which must be applied in order both to cause combustion to cease (by depriving the fire of oxygen) and to cool the combustible material below a likely ignition temperature are considerable and, in themselves, often result in significant damage to the property which it is intended to protect from the fire. Evidence suggests that when water hoses are used the damage done by the vast quantities of water which are typically pumped into a fire in a building cause almost as much to damage to those parts of the building which are not subject to fire as would have been caused by the fire itself.

In order to prevent fires from becoming established and causing the above problems, therefore, it is known to provide so-called fire extinguishers for use by anyone becoming aware of the commencement of a fire, for the purpose of suppressing or extinguishing the fire before it can get firmly established. Such fire extinguishers fall into three main categories, namely:

1. Water-jet fire extinguishers comprising a generally cylindrical container housing water and physical or chemical means for generating a propellant gas (or stored compressed gas) when triggered manually by an operator utilising a lever or other mechanism to rupture an enclosed bulb or other frangible container or to open a valve. This drives the water in the vessel out in a jet which is directed by the user at the seat of the flame. The theory of such extinguishers is that the water will cool the combustible material, partly by the transfer of heat to the water to raise it to its boiling point, and partly by the evaporation of the water, and the steam will displace the air thus starving the fire.

2. Powder extinguishers, which comprise a container of a fire retardant powder which is driven from the vessel explosively by the triggering mechanism and directed at the fire by the user. Such fire retardant chemicals primarily act by denying the fire access to oxygen.

3. Gas extinguishers which direct a jet of heavier-than-air displacement gas at the fire, again aiming to exclude the oxygen from the environment and thereby suppress the fire.

The latter two types of extinguisher are particularly indicated for fires where electrical apparatus is involved as the use of a water jet extinguisher could involve a risk of electrocution if the electrical apparatus is still “live” (that is connected to the mains network) whilst the fire is developing. All of the above fire extinguishers have the disadvantage that they require regular maintenance to maintain the condition of the high pressure vessel. Another disadvantage is that they require manual operation, which in turn means that only fires which have been detected by building's occupants can be dealt with. However, fires frequently commence when the occupants are asleep or otherwise occupied, and develop unnoticed to a point beyond that at which a hand-held fire extinguisher would have sufficient effect to justify the risk to the user of remaining in the vicinity of the fire.

Various attempts have been made to produce automatic fire suppressant or extinguisher apparatus which operates without the requirement for human intervention. One such fire extinguisher is described in U.S. Pat. No. 3,773,111 as a cylindrical container filled with a powder and having a nozzle at one end. A plunger or piston slides within the cylindrical container under the action of a pyrotechnic propellant which causes the powder to be delivered through the nozzle rapidly upon triggering by detection of flames. In operation high pressure is developed within the container which, therefore, must be built sufficiently strongly to withstand such pressures without rupture. Another fire or explosion suppressant is described in EP 0693303. This, too, is in the form of a cylindrical container having nozzles at one end and a propellant mechanism at the other. The cylinder is filled with a fire suppressant or extinguishant material although it is described that dry powder or water may also be used. The pressure generator operates to raise the pressure within the vessel very rapidly when triggered, to a very high level (1200 psi (8.27 MPa)) the rate of increase being in the order of 500 psi/ms (3.45 MPa/ms). The apparatus is intended to operate in such a way that substantially all of the extinguishant is discharged from the apparatus within less than 70 ms. U.S. Pat. No. 5,224,550 describes another fire suppressant or explosion protection system in which a detonating cord or explosive fuse is caused to ignite to cause a rapid generation of gas so as rapidly to discharge the fire suppressant materials from the container.

All these devices focus on the concept of rapid reaction and, consequently, need high pressure vessels in order to withstand the forces generated in use. They are focused on specific fires such as fires in engine compartments of motor vehicles or domestic cookers where they can be placed in close proximity to the anticipated seat of a fire and where, because of the nature of the fire expected to be encountered, an explosive detonation of fire suppressant may be expected, or even needed in order to cope with the particular circumstances encountered.

The present invention is, on the other hand, based on the premise that in the majority of environments at risk to fire there is no predictable seat for the fire and, consequently, the fire suppressant apparatus or extinguisher device must be capable of attacking a fire wherever in the environment it commences. This is particularly true, for example, in the domestic environment where individual rooms such as kitchens, dining rooms, lounges etc have furniture which itself is potentially combustible, as well as carpets, curtains and other soft furnishings all spaced in a configuration which differs from room to room. No automatic self-contained fire extinguisher currently available can provide protection automatically for such environments.

The present invention seeks to provide an improved self-contained fire extinguisher or suppressant apparatus which does not require a high pressure vessel, which can be located in a convenient location within a room and nevertheless provide protection for the entire volume of the room, is not subject to the loss over time of pressure in a propellant for a liquid medium contained in the apparatus, and which is capable, when activated, of expelling the fire suppressant medium in the form of a mist or fog.

According to one aspect of the present invention, therefore, fire suppressant apparatus comprises a container for a liquid fire suppressant material, at least one low pressure atomisation nozzle in communication with the interior of the container, and means for generating a propellant gas within the container whereby to maintain the interior of the container at a superatmospheric pressure sufficient to cause the suppressant liquid to be atomised as it passes through the nozzle for a time period sufficient to evacuate the contents of the container.

By utilising a low pressure atomisation nozzle it is possible to create the fire suppressant mist or fog without generating a high pressure within the container. It is possible, therefore, to utilise a container which does not need to be resistant to high pressures and, for example, in this connection it is anticipated that a pressure of 150 psi is likely to be the greatest pressure needed to expel the liquid fire suppressant material and atomise it to form a suppressant fog.

The means for generating a propellant gas preferably comprise the combustible, non-explosive fuel material which burns without requiring atmospheric oxygen. The charge of such material is preferably sufficient to burn over a period of at least several seconds, preferably from 10 to 20 seconds.

The present invention is based on the concept of creating a window of opportunity for persons within a closed environment subject to a fire to escape alive and undamaged by inhalation of hot combustion products or noxious gases. By generating a mist or fog of fire suppressant material, especially if the fire suppressant is water, the atmosphere is cooled by the Joule effect of atomisation, which lowers the temperature of the atomised droplets below ambient temperature. At the same time, by controlling the size of the droplets, and it is preferred that the atomisation nozzle is capable of producing atomised droplets of the fire suppressant liquid at least a major proportion of which are less than 100 μm in size, and preferably between 25 μm and

75 μm, such droplets will be suspended in the atmosphere for a considerable period of time, between 3 and 15 seconds. Indeed, tests have established that water droplets of 100 μm fall from a height of 2 m in approximately 3 seconds whereas water droplets at 50 μm will remain suspended for 30 seconds and water droplets of 10 μm for 10 minutes. By introducing water droplets the majority of which are in a size range on either side of 50 μm, therefore, the fog thus generated remains carried on the atmosphere and can be influenced by atmospheric movements. It will be appreciated that, in a closed environment such as the room in a building or the passenger compartment of a railway train, aircraft or road going vehicle, the occurrence of a fire at one point in the closed environment will cause circulated convection currents. Regardless of the precise location of the seat of the fire, therefore, the atomised droplets issuing from the fire suppressant apparatus can be carried by the convection currents down to a low level and laterally towards the source of the fire where they can act both to cool it, partly due to the low temperature of the water droplets and partly by the absorption of the heat for vaporisation, at the same time excluding atmospheric oxygen from the region of the fire. The entire volume of the protected environment is thus quickly filled with water droplets suppressing the generation of hot combustion products and allowing anyone in the environment a window of opportunity to escape to raise the alarm, obtain further fire fighting equipment or to call for professional fire fighters. Thus, even if the mist or fog generated by the fire suppressant apparatus of the present invention fails to extinguish the fire completely, it nevertheless suppresses it for sufficiently long to allow anyone present to escape and/or institute further measures for fire fighting.

It will be appreciated, therefore, that because the convection currents generated by the fire are utilised to convey the atomised droplets of fire suppressant liquid to the fire from the location of the fire suppressant apparatus, it is not necessary explosively to project the atomised droplets out from the apparatus, but rather merely to ensure that they have sufficient velocity to drift away from the apparatus, which in fact is encouraged by the natural tendency of the particles to separate from one another. The mist or fog thus formed effectively creates a wave front cooler than the atmospheric air which is carried by the convection currents on to the seat of the fire. Although the heat of the fire may cause evaporation of the mist or fog as it approaches the fire, this cold front continues to be fed from behind by further atomised droplets issuing from the apparatus over a period of time. Typically, it is envisaged that the gas generating device will continue to generate propellant gas for 15 to 20 seconds, which is slightly less than the amount of time necessary to eject the entirety of the liquid fire suppressant from the container. The residual pressure in the container will then eject the last of the liquid without generating excess pressure or jetting gases straight from the combustion.

Although a single atomisation nozzle may be provided, it is within the ambit of the present invention to provide apparatus having a plurality of low pressure nozzles all communicating with the interior of the container. Whether the nozzles deliver atomised droplets of fire suppressant liquid in different directions or the same direction is immaterial since it is the convection currents within the room which are expected to convey the droplets to the fire rather than the kinetic energy of the droplets as they are ejected from the apparatus.

In a preferred embodiment of the invention the nozzle or nozzles is or are mounted recessed below the surface of the container and covered with a or a respective cap or cover engaged to the container in such a way that it or they can be pushed off by the increased pressure when the propellant gas is generated. In practise there may be a small pocket of gas, in particular air, under the or each cap, which is compressed by the working pressure of the liquid to blow off the cap or caps.

This offers another advantage, especially if the or each cap or cover has an outer surface which, in the installed position on the container, is or are substantially flush with the outer surface of the container because it facilitates use of the apparatus in environments where interference or tampering with fire safety equipment may occur. Such environments, for example, as underground railway carriages are currently not supplied with hand-held fire extinguishers because of the problem of vandals setting off the fire extinguishers deliberately, even when there is no fire. This causes unwanted costs in replacement and/or recharging of fire extinguishers and has resulted in the withdrawal of such apparatus from this type of environment. However, with the apparatus of the present invention, which can be secured in position and triggered by the heat of a fire rather than a mechanical or manually-operated trigger, the opportunity for vandals corruptly to utilise the fire suppressant apparatus is effectively removed. This can be enhanced, moreover, by the fact that, since the cap or cover is ejected by the propellant gas pressure, the surface of the fire suppressant apparatus can be painted so as to conceal the precise location of the nozzles. Typically, for example, the or each cap or cover may be snap-engaged in an or a respective opening in the container.

A particularly convenient shape for the container is substantially spherical, although a cylindrical shape with domed ends may also be employed. In railway carriages or environments subject to potential vandalising, a tetrahedron shape may be employed so that the apparatus can be fitted into a corner of the compartment and have a substantially flat face directed in towards the compartment in a way which does not draw attention to the presence of the apparatus in the carriage.

As mentioned above, the ignition of the gas-generating means may be achieved by electrical or electronic ignition means which, preferably, includes a heat sensor operable to trigger the combustion of the gas generator means if the ambient temperature rises above a threshold value. The ignition means may also include means for detecting the rate of change of the ambient temperature, operable in conjunction with the said heat sensor to trigger the combustion of the gas generator if the rate of temperature increase exceeds a predetermined rate and/or if the absolute temperature exceeds a predetermined threshold at least for a predetermined time interval.

As the container does not have to withstand high pressures it may be formed as a low pressure plastics vessel. The use of plastics material is of particular advantage since it is light in weight and allows the atomisation nozzles to be integrally formed in the body of the container.

The present invention also comprehends a method of surpressing or extinguishing a fire in a protected environment, comprising generating a mist or fog of atomised water droplets at least the majority of which are less than 100 μm size, and preferably between 25 μm and 75 μm, and allowing the atomised droplets to be conveyed to the fire by the convection currents set up within the protected environment by the fire itself.

The water from which the atomised droplets are formed may have a fire retardant chemical dissolved or suspended therein so as to provide a further enhanced fire suppressant effect.

One embodiment of the present invention will now be more particularly described, by way of example, with reference to the accompanying drawing, in which:

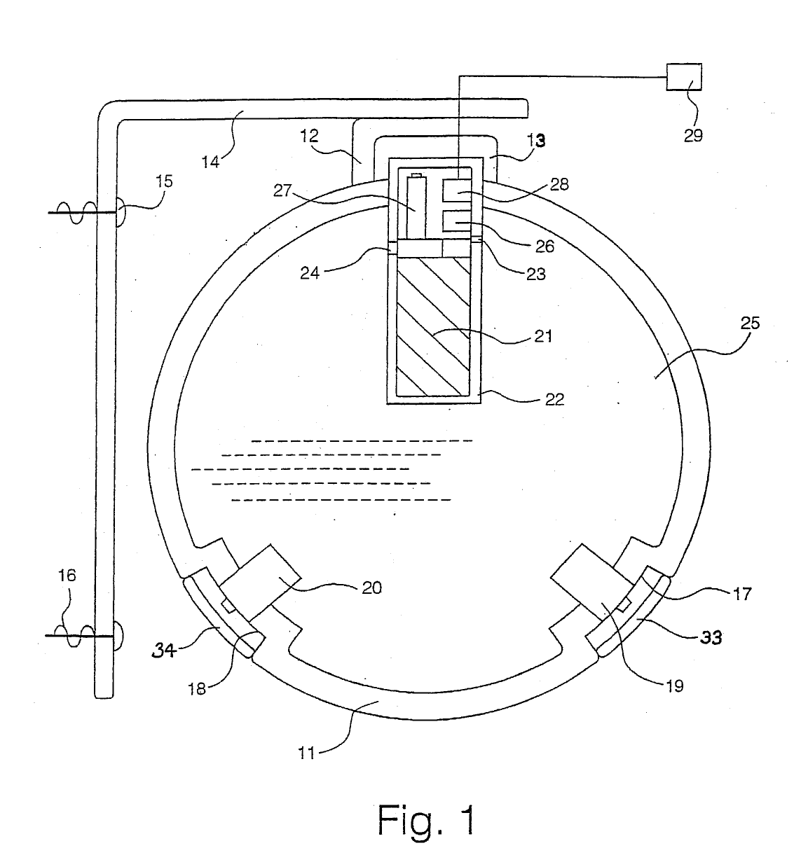

FIG. 1 is a sectional view of apparatus embodying the principles of the present invention; and

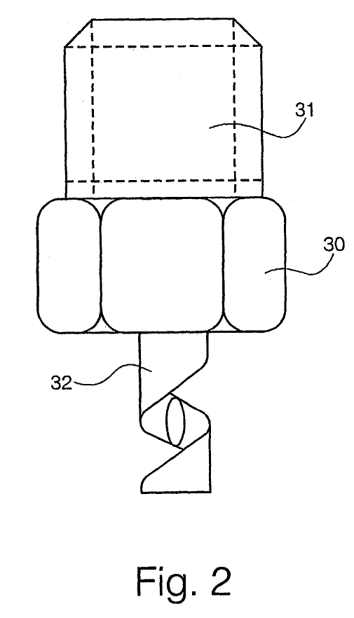

FIG. 2 is a side view of a nozzle suitable for use in the apparatus of FIG. 1.

The apparatus shown comprises a generally spherical container 11 of low-pressure plastics material sufficiently large to contain about 3 litres of water. A diameter of about 20 centimetres, equivalent to a small football, is sufficient for this purpose. The container has two upstanding lugs 12, 13 by means of which it can be suspended from a bracket generally indicated 14 which can be securely fixed to a wall such as by the fixing pins or screws 15, 16 illustrated.

With a charge of 3 litres of water the container is likely to weigh in the region of 3½ kg and this requires a secure mounting. Because of the way the apparatus will work to suppress fires it is important that the container be mounted at a high level, preferably as close to the ceiling as possible. However, ceiling structures are notoriously weak and it is unlikely that the location of a joist or rafter will be sufficiently certain for the device to be suspended from a ceiling. Accordingly, an L-shaped bracket such as that illustrated by the reference numeral 14 in the drawing is preferred as this allows the device to be secured to a wall rather than the ceiling, but nevertheless to be located substantially at the level of the ceiling.

In the wall of the container 11 are formed two recesses 17, 18, housing respective low pressure atomisation nozzles 19, 20. These nozzles are not of the pin-impact type, but rather a line-impact type which allows accurate atomisation of liquid passing therethrough over an extended contact line, which can be further extended by making it helical. Although individual discrete nozzles are illustrated, it is possible for nozzles to a suitable design to be formed integrally upon moulding of the container 11. Nozzles of this nature have the advantage of being particularly robust, and tests have established they will still function largely to produce atomised droplets even if slightly damaged by impact. An important consideration is that the nozzles should produce a majority of atomised droplets in the region of 50 μm at the working pressures generated by a propellant gas the means for generation of which will be described in more detail below. By providing water droplets of this size range the time taken for them to fall from ceiling height to a floor is in the region of 30 seconds, which is long enough for the convection currents set up by a fire to convey them across a room to exert their fire-suppressant influence. For this purpose the nozzles 19, 20 do not need to impart to the water droplets sufficient kinetic energy to convey them large distances, it being sufficient for them to be carried away from the immediate vicinity of the nozzle, and this results in avoiding the need for high pressure propellants.

FIG. 2 illustrates, on an enlarged scale, a suitable nozzle, represented as the nozzle 19, having a body 30 with a threaded section 31, for screwing the nozzle into position in an opening in the wall of the container 11, and a forwardly extending helical impact atomising member 32 which breaks the spray exiting an orifice (not shown) in the body 30 with a very fine aerosol with particles mostly in the region of 50 μm. The helical input line ensures a high rate of delivery even at the fine atomisation rate mentioned above.

The propellant gas is generated by a combustible material, for example one produced by Atlantic Research Company under the Trade Name “Arcite” which is combustible even in an enclosed environment without an external supply of oxygen. Moreover, this material burns slowly and is stable and safe to be left in a domestic environment for long periods without risk of ignition.

The combustible material 21 is housed in a container 22, which may be a metal or ceramic casing having openings 23, 24 to allow gas resulting from combustion to escape into the interior chamber 25 of the container 11. These openings 23, 24 are open to the interior chamber and allow liquid to enter the casing 22. Upon generation of appropriate pressure by combustion of the material 21, any liquid in the casing 22 is ejected into the interior 25 of the container 11 along with the generated gas. The combustible material 21 is ignitable even in the presence of water and the combustion thereof is unaffected by the presence of water.

Combustion of the material 21 is initiated by an electronic ignitor 26 powered by a battery 27 which also supplies a heat sensor 28 the output signal from which triggers the operation of the ignitor 26. A processor 29 which includes a battery state circuit and a timer, is connected to the sensor 28 and to the ignitor 26 and programmed to determine the rate of increase of temperature as well as the absolute temperature so that anomalous temperature variations for a short period, or slowly varying temperatures not likely to indicate the presence of a fire do not trigger spurious energisations of the ignitor 26.

The interior 25 of the vessel 11 is filled with water which completely immerses the gas generator 22 with no included air.

Over the recesses 17, 18 housing the nozzles 19, 20 are respective covers 33, 34 which are snap engaged into place in the recesses 17, 18 and the outer surfaces of which are substantially flush with the outer surface of the container 11. These covers 33, 34 cannot be removed manually from the recesses 17, 18 as there are no points of purchase at which an individual may dislodge the caps or covers from their position. Tampering or corruption therefore is unlikely.

The apparatus of the present invention thus comprises a self-contained low-pressure device which produces a water fog when triggered. The atomised droplets of the water fog have a limited droplet size which allows them to remain in the atmosphere for an extended time period, and the gas generator operates to generate gas for an extended time period so that the water within the chamber 25 is expelled relatively slowly, typically in a time period of 15 to 20 seconds without the generation of a high pressure so that the vessel 11 can be made of a low pressure plastics material. The propellant charge burns to produce nitrogen, carbon dioxide and water which are, themselves, not noxious gases, and the excess gas within the vessel when the water is all expelled, itself escapes through the nozzles and helps further to disperse the atomised water droplets towards the seat of the fire.

The method of fire suppression using a low-energy water fog has the advantage that the fog itself acts as a heat shield between the fire and the rest of the room, and absorbs radiated heat as well as slowing the convective flow by lowering the temperature of the fire seat. This, therefore, stops the fire jumping from one source of combustible material to another by radiated heat. The low-temperature water droplets can be inhaled by a person in the room without damage. Fire retardant chemicals may be included in aqueous solution or suspension in the water within the chamber 25, and this offers the advantage of providing a smoke cleansing effect by absorbing smoke particles in the atomised droplets. This is beneficial as human lungs can handle the inhalation of water droplets better than the inhalation of smoke particles.

Moreover, because a relatively small volume of water is utilised to generate the fog there is little collateral damage to the interior of a room or the furniture by wetting, and unlike the situation with conventional water jet fire extinguishers.

Although a single individual fire suppressant device has been described, it will be appreciated that a plurality of such devices may be linked together to protect a larger environment, and these may act individually or be connected such as to be triggered together when a control sensor detects the occurrence of a fire.

In another application the device may be used as a security device by incorporating a dye in the liquid within the chamber 25 and having further triggering means linked to an intruder detector such as a passive infra-red detector. The dye may, for example, be one which only shows up under ultra-violet light. If an intruder enters the room when the alarm is set, therefore, the device of the invention is triggered to issue a fine mist which will saturate the intruders skin and clothes as well as coating any items within the room so that both the intruder himself (or herself) and any stolen goods can readily be identified at a later date.

Although in the embodiment described the gas generating system in the canister 22 is shown located at an upper position within the container 11 it could be located at other positions, for example at a lower position between the nozzles 19, 20, or at an “equatorial” position midway between the upper and lower positions. It could even be freely located within the interior, unsecured to the interior wall, as long as it is connected to the wire from the sensor 29 for triggering purposes, of course, the replaceable battery would then have to be positioned differently.

1. Fire suppressant apparatus, comprising a container for a liquid fire suppressant material, an outlet (19, 20) from the container (11) for the fire suppressant material, and means (21, 22) for generating a propellant gas within the container (11) whereby to raise the interior of the container (11) to a superatmospheric pressure, sufficient to cause the fire suppressant liquid to be expelled from the container (11), characterised in that the outlet (19, 20) from the container comprises at least one low pressure atomisation nozzle (19, 20) mounted on the wall of the container (11) and operable to produce atomised droplets the majority of which are less than 100 μm in size from a pressure less than 150 psi.

2. Apparatus according to claim 1, characterised in that the said means (21, 22) for generating a propellant gas comprise a combustible, non-explosive fuel material (21) which burns without requiring atmospheric oxygen over a period of at least several seconds.

3. Apparatus according to claim 1 or claim 2, characterised in that the atomisation nozzle (19, 20) produces atomised droplets of fire suppressant liquid at least the majority of which are between 25 μm and 75 μm in size.

4. Apparatus according to any preceding claim, characterised in that there are a plurality of low pressure nozzles (19, 20) in the wall of the container 11 all communicating with the interior of the container (11).

5. Apparatus according to any preceding claim, characterised in that the nozzle or nozzles (19, 20) is or are mounted in recesses (17, 18) below the surface of the container which are covered with an or a respective cap (33, 34) or cover snap-engaged to the container (11) in such a way that it or they can be displaced by the working pressure of fluid ejected from the nozzles (19, 20) by the said propellant gas.

6. Apparatus according to claim 5, characterised in that the or each cap or cover (33, 34) has an outer surface which, in the installed position on the container, is or are substantially flush with the outer surface of the container (11).

7. Apparatus according to any preceding claim, characterised in that the container (11) is substantially spherical.

8. Apparatus according to any of claims 2 to 7, characterised in that the combustion of the gas generator (21) is initiated by electrical or electronic ignition means (26).

9. Apparatus according to claim 8, characterised in that the electrical or electronic ignition means (26) includes a heat sensor (28) operable to trigger the combustion of the gas generator means (26) if the ambient temperature rises above a threshold value.

10. Apparatus according to claim 9, characterised in that the said ignition means (21, 22) includes means (29) for detecting the rate of change of the ambient temperature, operable in conjunction with the said heat sensor (28) to trigger the combustion of the gas generator means (26) if the rate of temperature increase exceeds a predetermined rate and/or if the absolute temperature exceeds a predetermined threshold at least for a predetermined time interval.

11. Apparatus according to any preceding claim, characterised in that the said container (11) is a low pressure plastics vessel.

12. Apparatus according to any preceding claim, characterised in that the or each low pressure atomisation nozzle (19, 20) is integrally formed in the body of the container (11).

13. A method of suppressing or extinguishing a fire in a protected environment, comprising generating a mist of fog of atomised water droplets at least the majority of which are less than 100 μm in size, and preferably between 25 μm and 75 μm, and allowing the atomised droplets to be conveyed to the fire by the convection current set up within the protected environment by the fire.

14. A method as claimed in claim 14, in which the water from which the atomised droplets are formed has a fire retardant chemical dissolved or suspended therein.
